(19) United States
(12) Patent Application Publication
(10) Pub. No.: US 2026/0334501 A1
(43) Pub. Date: Oct. 29, 2026

(54) SLUSH MACHINE WITH CONVENIENTLY DETACHABLE LOADING CONTAINER

(71) Applicant: Zhuhai Yingweituo Technology Co., Ltd., Zhuhai (CN)

(72) Inventor: Yisheng LI, Zhuhai (CN)

(73) Assignee: Zhuhai Yingweituo Technology Co., Ltd., Zhuhai (CN)

(21) Appl. No.: 19/336,489

(22) Filed: Sep. 22, 2025

(30) Foreign Application Priority Data
Apr. 29, 2025 (CN) 2025208494323

(51) Int. Cl. A23G 9/04; A23G 9/12; A23G 9/22

(52) U.S. Cl. CPC A23G 9/045; A23G 9/12; A23G 9/222

(57) ABSTRACT

A slush machine with a conveniently detachable loading container includes: a main unit and a loading container. One of the main unit and the loading container is provided with linkage self-locking assemblies, and the other is provided with corresponding engagement portions. Each linkage self-locking assembly includes a base, a swing arm, and a clutch member. The base is fixedly arranged on the main unit or the loading container. One end of the swing arm is rotatably connected to the base through a first pivot, and another end thereof is rotatably connected to the clutch member through a second pivot. An end of the clutch member is detachably connected to the engagement portion, and the clutch member is movable relative to the base to define an unlocked state and a self-locked state.

### CROSS-REFERENCE TO RELATED APPLICATION

This application is based on and claims the benefit of priority from Chinese Patent Application No. 2025208494323, filed on 29 Apr. 2025, the entirety of which is incorporated by reference herein.

### TECHNICAL FIELD

The present disclosure relates to the technical field of household appliances, and in particular, to a slush machine with a conveniently detachable loading container.

### BACKGROUND

In the related art, in order to facilitate the cleaning of the loading container for storing shaved ice of the slush machine, the loading container is configured to be detachably connected to the slush main unit. The loading container is first moved in position, and then the position of the loading container is fixed by a locking mechanism provided between the slush main unit and the loading container. Ordinary locking mechanisms require that both the slush main unit and the loading container are provided with a relatively complex connection structure, and either the steps for disassembling and assembling the loading container are cumbersome to ensure reliability, or the locking effect is compromised.

### SUMMARY

In order to overcome the deficiencies in the existing technologies, one of the objectives of the present disclosure is to provide a slush machine with a conveniently detachable loading container, which is easy to assemble and disassemble and has reliable locking.

In accordance with an embodiment of the utility model, the slush machine with a conveniently detachable loading container includes: a main unit and a loading container, where one of the main unit and the loading container is provided with at least two linkage self-locking assemblies arranged along a circumferential direction of the loading container, and another one of the main unit and the loading container is provided with engagement portions corresponding to the respective linkage self-locking assemblies; each of the linkage self-locking assemblies includes a base, a swing arm, and a clutch member, the base is fixedly arranged on an outer peripheral wall of the main unit or an outer peripheral wall of the loading container, one end of the swing arm is rotatably connected to the base through a first pivot, another end of the swing arm is rotatably connected to the clutch member through a second pivot, an end of the clutch member is detachably connected to the respective engagement portion, and the clutch member is movable relative to the base to define an unlocked state and a self-locked state; in case that the clutch member is in the self-locked state and the loading container is pulled and tends to move away from the main unit, the swing arm drives the clutch member to abut against the outer peripheral wall of the main unit or the outer peripheral wall of the loading container such that an opening of the loading container remains in abutment with the main unit.

According to the slush machine of the above structure, the engagement portion is connected to the clutch member when the loading container is mounted, and then the clutch member is driven to rotate relative to the swing arm around the second pivot to be in the self-locked state. During this process, the clutch member links the swing arm to rotate relative to the base around the first pivot. When the loading container is pulled away from the main unit, the swing arm locks the angle position of the clutch member to prevent the loading container from falling off. When the loading container is disassembled, the clutch member is driven to rotate around the second pivot relative to the swing arm to be in the unlocked state. The clutch member is separated from the engagement portion. This enables easy attachment and detachment of the container with reliable locking.

In some embodiments of the present disclosure, each of the engagement portions is a hook fixedly mounted on the outer peripheral wall of the loading container; a groove matched with the hook is provided on the end of the clutch member; the main unit has a mounting surface for fixing the base; a distance between the first pivot and the mounting surface is a; in case that the clutch member is in the self-locked state, the clutch member abuts against the mounting surface; and the distance between the second pivot and the mounting surface is b, satisfying b<a.

In some embodiments of the present disclosure, a torsion spring is arranged around the second pivot, and one end of the torsion spring abuts against the swing arm and another end of the torsion spring abuts against the clutch member to prevent the hook from being separated from the groove.

In some embodiments of the present disclosure, the clutch member has a cover shell covering the base and the swing arm; the second pivot passes through the cover shell; the groove is arranged to extend through an end of the cover shell; an operating handle is provided extending from one end of the cover shell away from the groove; and in case that the operating handle rotates around the second pivot in a direction away from the main unit, the swing arm rotates around the first pivot to make the groove be separated from the hook.

In some embodiments of the present disclosure, a clearance gap is arranged between the operating handle and the main unit, and an arc guide surface is arranged on an inner side of the hook, and the arc guide surface abuts against a side edge of the groove; in case that the operating handle rotates around the second pivot in the direction away from the main unit, the side edge of the groove is slidable along the arc guide surface to be separated from the hook.

In some embodiments of the present disclosure, the main unit is provided with a horizontal slide groove, the loading container is slidably arranged in the slide groove, the main unit is provided with an ice-making assembly capable of horizontally extending into the loading container, the main unit is provided with a mounting seat capable of closing the opening of the loading container at an end of the slide groove, two hooks are formed on opposite side surfaces of the loading container, and the at least two linkage self-locking assemblies includes two linkage self-locking assemblies arranged on both sides of the mounting seat respectively, and the torsion spring is configured to drive one end of the clutch member to abut against the outer peripheral wall of the loading container such that the hook is clamped to the groove.

In some embodiments of the present disclosure, the mounting seat is provided with a sealing ring elastically abutting against an inner peripheral edge of the opening of the loading container.

In some embodiments of the present disclosure, the hook includes a connecting section protruding from the outer peripheral wall of the loading container and an extending section connected to the connecting section and extending in a direction away from the mounting seat; the connecting section has a guiding slope facing the respective linkage self-locking assembly; the torsion spring is configured to drive one end of the clutch member close to the groove to elastically abut against the outer peripheral wall of the loading container; and the opening of the loading container moves towards the mounting seat such that one end of the clutch member moves along the guiding slope until the extending section is inserted into the groove.

In some embodiments of the present disclosure, the base is detachably mounted on the mounting surface.

In some embodiments of the present disclosure, the base is provided with at least two elastic buckle portions at an interval, the mounting surface is provided with clamping grooves corresponding to the respective elastic buckle portions, the base is provided with a through hole, the mounting surface is provided with a threaded hole facing the through hole, and a threaded fastener is arranged to pass through the through hole to be connected to the threaded hole to prevent the base from being separated from the main unit.

Additional aspects and advantages of the present disclosure will be given in part in the following description, and in part will become apparent from the following description, or will be learned through the practice of the present disclosure

### BRIEF DESCRIPTION OF DRAWINGS

The present disclosure is further described below in conjunction with the accompanying drawings and embodiments.

FIG. 1 is a schematic structural view of a slush machine with a conveniently detachable loading container according to an embodiment of the present disclosure;

FIG. 2 is a schematic structural view of a loading container and a main unit separated from each other in the embodiment of FIG. 1;

FIG. 3 is a partial cross-sectional schematic view of a linkage self-locking assembly of the embodiment of FIG. 1; and

FIG. 4 is a partial schematic view of the linkage self-locking assembly and a hook separated from each other in the embodiment of FIG. 1.

### REFERENCE NUMERALS

main unit 100; sliding groove 110; mounting seat 120; mounting surface 130; clamping groove 131; threaded hole 132; loading container 200; linkage self-locking assembly 300; base 310; elastic buckle portion 311; through hole 312; swing arm 320; clutch member 330; groove 331; cover shell 332; operating handle 333; first pivot 340; second pivot 350; torsion spring 360; hook 400; connecting section 410; guiding slope 411; arc guide surface 412; extending section 420; ice-making assembly 500; sealing ring 600.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by the terms such as “upper”, “lower”, “front”, “rear”, “left”, “right”, “vertical”, “horizontal”, “top”, “bottom”, “inner”, “outer”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense. For example, they may be a fixed connection, or a detachable connection, or an integrated connection, may be a mechanical connection or an electric connection, may be a direct connection or an indirect connection through an intermediation, or may be an internal connection between two elements. Those of ordinary skill in the art can determine the specific meanings of the above words in the present disclosure in a rational way in combination with the specific contents of the technical solutions.

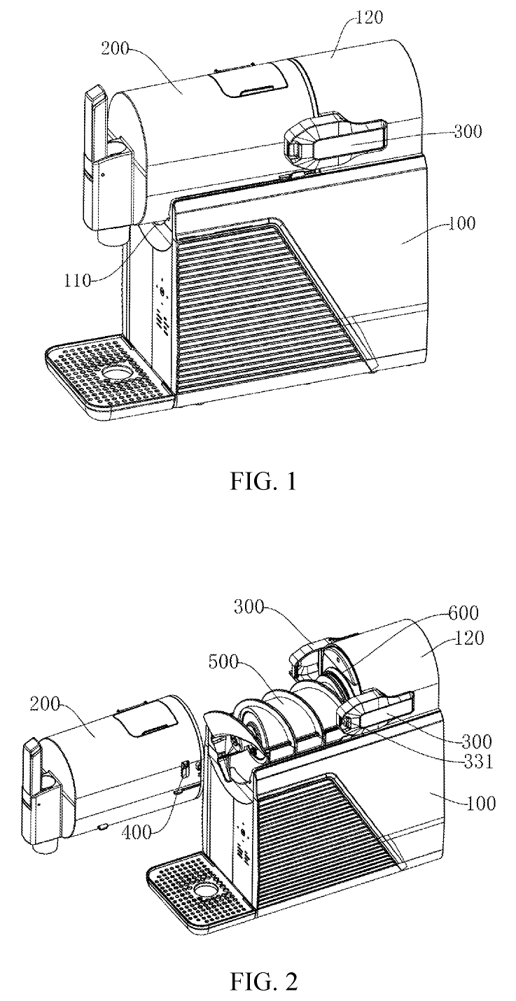

Referring to FIGS. 1-4, a slush machine with a conveniently detachable loading container 200 of the present disclosure includes: a main unit 100 and a loading container 200. One of the main unit 100 and the loading container 200 is provided with at least two linkage self-locking assemblies 300 arranged along a circumferential direction of the loading container 200, and another one of the main unit and the loading container is provided with engagement portions corresponding to the respective linkage self-locking assemblies 300. Each of the linkage self-locking assemblies 300 includes a base 310, a swing arm 320, and a clutch member 330. The base 310 is fixedly arranged on an outer peripheral wall of the main unit 100 or an outer peripheral wall of the loading container 200. One end of the swing arm 320 is rotatably connected to the base 310 through a first pivot 340, another end of the swing arm 320 is rotatably connected to the clutch member 330 through a second pivot 350. An end of the clutch member 330 is detachably connected to the engagement portion, and the clutch member 330 is movable relative to the base 310 to define an unlocked state and a self-locked state. When the clutch member 330 is in the self-locked state, if the loading container 200 is pulled and tends to move away from the main unit 100, the swing arm 320 drives the clutch member 330 to abut against the outer peripheral wall of the main unit 100 or the outer peripheral wall of the loading container 200 such that an opening of the loading container 200 remains in abutment with the main unit 100.

According to the slush machine of the above structure, the engagement portion is connected to the clutch member 330 when the loading container 200 is mounted, and then the clutch member 330 is driven to rotate relative to the swing arm 320 around the second pivot 350 to be in the self-locked state. During this process, the clutch member 330 links the swing arm 320 to rotate relative to the base 310 around the first pivot 340. When the loading container 200 is pulled away from the main unit 100, the swing arm 320 locks the angle position of the clutch member 330 to prevent the loading container 200 from falling off. When the loading container 200 is disassembled, the clutch member 330 is driven to rotate around the second pivot 350 relative to the swing arm 320 to be in the unlocked state. During this process, the swing arm 320 also rotates around the first pivot 340 relative to the base 310 to unlock the angular position of the clutch member 330. The clutch member 330 is separated from the engagement portion. This enables easy attachment and detachment of the container 200 with reliable locking.

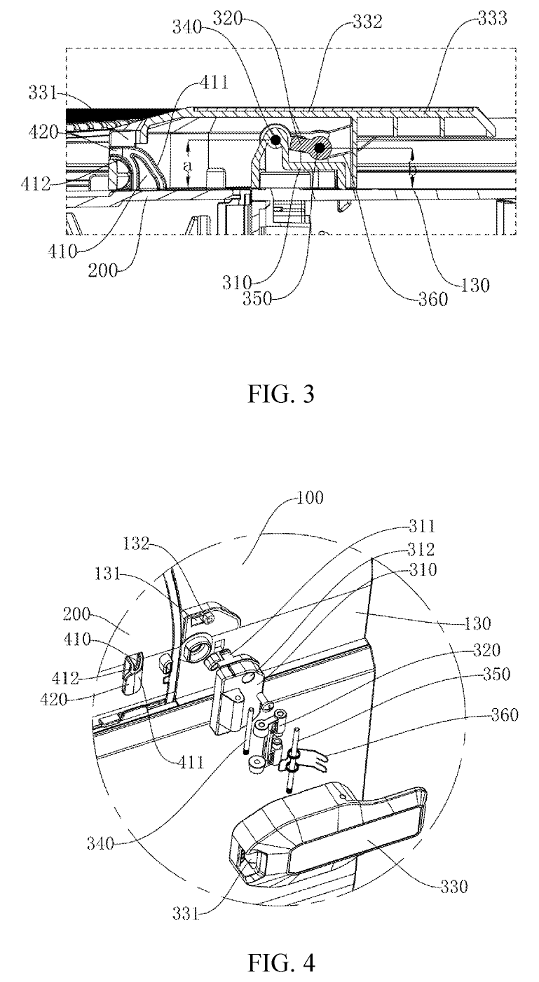

Referring to FIG. 3, in some embodiments of the present disclosure, each of the engagement portions is a hook 400 fixed to the outer peripheral wall of the loading container 200, and a groove 331 matched with the hook 400 is provided on the end of the respective clutch member 330. The main unit 100 has a mounting surface 130 for fixing the base 310, and a distance between the first pivot 340 and the mounting surface 130 is a. When the clutch member 330 is in the self-locked state, the clutch member 330 abuts against the mounting surface 130, and a distance between the second pivot 350 and the mounting surface 130 is b, satisfying b < a. It can be understood that when the loading container 200 is mounted, the clutch member 330 is moved until the hook 400 can be inserted into the groove 331, and then the clutch member 330 is driven to rotate around the second pivot 350 relative to the swing arm 320 and abut against the main unit 100. At the same time, the swing arm 320 rotates around the first pivot 340 relative to the base 310 to move the second pivot 350 towards the mounting surface 130. The clutch member 330 acts on the hook 400 to pull the loading container 200 towards the main unit 100 to close the opening of the loading container 200. When b < a is satisfied, the clutch member 330 is in the self-locked state. It should be noted that when the contact point between the hook 400 and the groove 331, the axis of the first pivot 340, and the axis of the second pivot 350 are collinear, the linkage self-locking assembly 300 is in a dead point position. When b < a is satisfied, the axis of the second pivot 350 passes the dead point position. At this time, no matter how much pulling force is applied to the loading container 200, the loading container 200 cannot be separated from the main unit 100.

Referring to FIGS. 3 and 4, in some embodiments of the present disclosure, in order to avoid accidental unlocking of the clutch member 330 due to a light touch causing the clutch member 330 to rotate and ensure that the opening of the loading container 200 can be stably sealed, a torsion spring 360 is arranged around the second pivot 350, and one end of the torsion spring 360 abuts against the swing arm 320 and another end of the torsion spring 360 abuts against the clutch member 330. The torsion spring 360 drives the clutch member 330 to abut against the main unit 100, such that the groove 331 keeps pulling the hook 400 to move towards the main unit 100, thereby preventing the hook 400 from being separated from the groove 331.

Referring to FIGS. 1 and 3, in some embodiments of the present disclosure, the clutch member 330 has a cover shell 332 covering the base 310 and the swing arm 320, the second pivot 350 passes through the cover shell 332, the groove 331 is arranged to extend through an end of the cover shell 332, and an operating handle 333 extends from one end of the cover shell 332 away from the groove 331. When the operating handle 333 rotates around the second pivot 350 in a direction away from the main unit 100, the swing arm 320 rotates around the first pivot 340 to make the groove 331 be separated from the hook 400. Specifically, the cover shell 332, the operating handle 333, and the groove 331 are of an integrated plastic structure. The cover shell 332 can protect the base 310, the swing arm 320, and the torsion spring 360 to avoid accidental touch and dust accumulation. The arrangement of the operating handle 333 makes it easier to rotate the clutch member 330 around the second pivot 350.

Referring to FIGS. 3 and 4, in some embodiments of the present disclosure, a clearance gap is arranged between the operating handle 333 and the main unit 100, and an inner side of the hook 400 has an arc guide surface 412, and the arc guide surface 412 abuts against a side edge of the groove 331. When the operating handle 333 rotates around the second pivot 350 in a direction away from the main unit 100, the side edge of the groove 331 can slide along the arc guide surface 412 to be separated from the hook 400. It can be understood that the clearance gap allows for four fingers of the user to reach in. When the user drives the operating handle 333 to rotate away from the main unit 100, the side edge of the groove 331 slides out along the arc guide surface 412, thereby realizing the separation of the groove 331 of the clutch member 330 from the hook 400. This makes disassembling of the loading container 200 very convenient.

Referring to FIG. 2, in some embodiments of the present disclosure, the main unit 100 is provided with a horizontal slide groove 110, the loading container 200 is slidably arranged in the slide groove 110. The main unit 100 is provided with an ice-making assembly 500 that can horizontally extend into the loading container 200. The main unit 100 is provided with a mounting seat 120 that can close the opening of the loading container 200 at an end of the slide groove 110. The two hooks 400 are formed on the opposite side surfaces of the loading container 200. Two sides of the mounting seat 120 are provided with the respective linkage self-locking assemblies 300. The torsion spring 360 drives one end of the clutch member 330 to abut against the outer peripheral wall of the loading container 200 such that the hook 400 is clamped to the groove 331. It can be understood that when the loading container 200 is assembled, the loading container 200 is placed in the slide groove 110 and pushed in along the depth direction of the slide groove 110. At this time, the ice-making assembly 500 enters the loading container 200. When the opening of the loading container 200 abuts against the corresponding position on the mounting seat 120, the two linkage self-locking assemblies 300 are respectively connected to the two hooks 400 to lock the loading container 200 on the main unit 100. When the loading container 200 is disassembled, it is only necessary to unlock the clutch members 330 of the linkage self-locking assemblies 300 and then slide the loading container 200 off the slide groove 110.

Referring to FIG. 2, in some embodiments of the present disclosure, in order to improve the sealing effect of the mounting seat 120 on the opening of the loading container 200, the mounting seat 120 is provided with a sealing ring 600 elastically abutting against the inner peripheral edge of the opening of the loading container 200.

Referring to FIGS. 3 and 4, in some embodiments of the present disclosure, the hook 400 includes a connecting section 410 protruding from the outer peripheral wall of the loading container 200 and an extending section 420 connected to the connecting section 410 and extending in a direction away from the mounting seat 120. The connecting section 410 has a guiding slope 411 facing the respective linkage self-locking assembly 300. The torsion spring 360 drives one end of the clutch member 330 close to the groove 331 to elastically abut against the outer peripheral wall of the loading container 200, and the opening of the loading container 200 moves towards the mounting seat 120 such that one end of the clutch member 330 moves along the guiding slope 411 until the extending section 420 is inserted into the groove 331. It can be understood that when the opening of the loading container 200 moves toward the mounting seat 120, one end of the clutch member 330 can contact the guiding slope 411. As the opening of the loading container 200 continues to move toward the mounting seat 120, one end of the clutch member 330 moves along the guiding slope 411 and rotates. When the extending section 420 passes over the end edge of the clutch member 330, the extending section 420 can be inserted into the groove 331 and remain stable under the action of the torsion spring 360.

Referring to FIG. 4, in some embodiments of the present disclosure, the base 310 is detachably mounted on the mounting surface 130. It can be understood that the base 310 and the main unit 100 are separately arranged, and the base 310 is produced and processed separately and then assembled on the main unit 100, which is helpful to reduce the processing difficulty.

Referring to FIG. 4, in some embodiments of the present disclosure, the base 310 is provided with at least two elastic buckle portions 311 at an interval, the mounting surface 130 is provided with clamping grooves 131 corresponding to the respective elastic buckle portions 311, the base 310 is provided with a through hole 312, the mounting surface 130 is provided with a threaded hole 132 facing the through hole 312, and a threaded fastener passes through the through hole 312 to be connected to the threaded hole 132 to prevent the base 310 from being separated from the main unit 100. Specifically, when the base 310 is assembled, the elastic buckle portions 311 are inserted into the respective clamping grooves 131, and then the threaded fasteners pass through the through holes 312 to be tightened in the threaded holes 132 to prevent the base 310 from being relatively deviated.

The technical features of the above embodiments may be combined in any manner. To make the description concise, not all possible combinations of the technical features in the above embodiments are described. However, as long as there is no contradiction in the combination of these technical features, they should be considered to be within the scope of this specification.

Although the embodiments of the present disclosure have been shown and described, it will be understood by those of ordinary skills in the art that various changes, modifications, substitutions, and variations may be made to these embodiments without departing from the principle and gist of the present disclosure, the scope of which is defined by the claims and their equivalents.

What is claimed is:

1. A slush machine with a conveniently detachable loading container, comprising:
a main unit and a loading container, wherein one of the main unit and the loading container is provided with at least two linkage self-locking assemblies arranged along a circumferential direction of the loading container, and another one of the main unit and the loading container is provided with engagement portions corresponding to the respective linkage self-locking assemblies; each of the linkage self-locking assemblies comprises a base, a swing arm, and a clutch member, the base is fixedly arranged on an outer peripheral wall of the main unit or an outer peripheral wall of the loading container, one end of the swing arm is rotatably connected to the base through a first pivot, another end of the swing arm is rotatably connected to the clutch member through a second pivot, an end of the clutch member is detachably connected to the respective engagement portion, and the clutch member is movable relative to the base to define an unlocked state and a self-locked state; in case that the clutch member is in the self-locked state and the loading container is pulled and tends to move away from the main unit, the swing arm drives the clutch member to abut against the outer peripheral wall of the main unit or the outer peripheral wall of the loading container such that an opening of the loading container remains in abutment with the main unit.

2. The slush machine with a conveniently detachable loading container according to claim 1, wherein each of the engagement portions is a hook fixedly mounted on the outer peripheral wall of the loading container; a groove matched with the hook is provided on the end of the clutch member; the main unit has a mounting surface for fixing the base; a distance between the first pivot and the mounting surface is a; in case that the clutch member is in the self-locked state, the clutch member abuts against the mounting surface; and the distance between the second pivot and the mounting surface is b, satisfying b<a.

3. The slush machine with a conveniently detachable loading container according to claim 2, wherein a torsion spring is arranged around the second pivot, and one end of the torsion spring abuts against the swing arm and another end of the torsion spring abuts against the clutch member to prevent the hook from being separated from the groove.

4. The slush machine with a conveniently detachable loading container according to claim 2, wherein the clutch member has a cover shell covering the base and the swing arm; the second pivot passes through the cover shell; the groove is arranged to extend through an end of the cover shell; an operating handle is provided extending from one end of the cover shell away from the groove; and in case that the operating handle rotates around the second pivot in a direction away from the main unit, the swing arm rotates around the first pivot to make the groove be separated from the hook.

5. The slush machine with a conveniently detachable loading container according to claim 4, wherein a clearance gap is arranged between the operating handle and the main unit, and an arc guide surface is arranged on an inner side of the hook, and the arc guide surface abuts against a side edge of the groove; in case that the operating handle rotates around the second pivot in the direction away from the main unit, the side edge of the groove is slidable along the arc guide surface to be separated from the hook.

6. The slush machine with a conveniently detachable loading container according to claim 3, wherein the main unit is provided with a horizontal slide groove, the loading container is slidably arranged in the slide groove, the main unit is provided with an ice-making assembly capable of horizontally extending into the loading container, the main unit is provided with a mounting seat capable of closing the opening of the loading container at an end of the slide groove, two hooks are formed on opposite side surfaces of the loading container, and the at least two linkage self-locking assemblies comprises two linkage self-locking assemblies arranged on both sides of the mounting seat respectively, and the torsion spring is configured to drive one end of the clutch member to abut against the outer peripheral wall of the loading container such that the hook is clamped to the groove.

7. The slush machine with a conveniently detachable loading container according to claim 6, wherein the mounting seat is provided with a sealing ring elastically abutting against an inner peripheral edge of the opening of the loading container.

8. The slush machine with a conveniently detachable loading container according to claim 6, wherein the hook comprises a connecting section protruding from the outer peripheral wall of the loading container and an extending section connected to the connecting section and extending in a direction away from the mounting seat; the connecting section has a guiding slope facing the respective linkage self-locking assembly; the torsion spring is configured to drive one end of the clutch member close to the groove to elastically abut against the outer peripheral wall of the loading container; and the opening of the loading container moves towards the mounting seat such that one end of the clutch member moves along the guiding slope until the extending section is inserted into the groove.

9. The slush machine with a conveniently detachable loading container according to claim 2, wherein the base is detachably mounted on the mounting surface.

10. The slush machine with a conveniently detachable loading container according to claim 9, wherein the base is provided with at least two elastic buckle portions at an interval, the mounting surface is provided with clamping grooves corresponding to the respective elastic buckle portions, the base is provided with a through hole, the mounting surface is provided with a threaded hole facing the through hole, and a threaded fastener is arranged to pass through the through hole to be connected to the threaded hole to prevent the base from being separated from the main unit.
